(19) United States
(12) Patent Application Publication
(10) Pub. No.: US 2016/0130127 A1
(43) Pub. Date: May 12, 2016

(54) Portable Mixed Drink Dispensing Unit

(71) Applicant: Hamilton Beach Brands, Inc., Glen Allen, VA (US)

(72) Inventors: Terry Copenhaver, Glen Allen, VA (US); James Robert Gaynor, Richmond, VA (US)

(21) Appl. No.: 14/535,452

(22) Filed: Nov. 7, 2014

(51) Int. Cl. B67D 1/00; B67D 1/10

(52) U.S. Cl. CPC B67D 1/0037; B67D 1/0043; B67D 1/10

(57) ABSTRACT

A portable mixed drink dispensing unit includes a portable enclosure defining an interior space. A first reservoir within the interior space is secured to the enclosure and fluidly connectable to at least one liquid container containing a first liquid. A removable second reservoir is included in the interior space and contains a second liquid. A mixing unit located within the interior space has an inlet and an outlet. The mixing unit is in individual fluid communication at the inlet with the first and second reservoirs for separately receiving the first and second liquids. The mixing unit is configured to prepare a mixed drink by mixing the first and second liquids at a predetermined ratio, and to output the mixed drink via the outlet. A tap lever is in fluid communication with the outlet of the mixing unit, for dispensing the mixed drink.

### BACKGROUND OF THE DISCLOSURE

The present disclosure is generally directed to a portable mixed drink dispensing unit, and more particularly to a portable cocktail dispensing unit that prepares the cocktail at a predetermined fixed ratio of non-alcohol to alcohol.

Preparing and serving mixed drinks, e.g., cocktails, generally requires staff, e.g., waiters or bartenders, who are trained and available to manually prepare the drinks, i.e., pour and mix the liquid components, prior to serving. Preparing a mixed drink is generally a more time consuming process than preparing a single component drink, as measured quantities of the individual liquid components must be poured and mixed together thereafter. Further, regardless of experience, mixed drinks prepared by an individual are unlikely to be consistently and repeatedly prepared at a substantially set mix ratio of one liquid component to the other. Thus, often, purchasers or guests are unhappy that the drink, e.g., a cocktail, is too light or too strong with respect to one component of the drink compared to the other.

Therefore, it would be advantageous to have a dispensing unit that prepares mixed drinks efficiently and at a substantially consistent and repeatable predetermined or fixed ratio between the liquid components of the drink. It would also be advantageous to manufacture such a unit in a portable and self-sustaining manner, such that a waiting staff can set it up and utilize it anywhere, such as, for example, in a restaurant, office, residence or outdoors. It would be also advantageous to package such a unit in a substantially closed enclosure, hiding the components of the unit therein, for a more aesthetic overall appearance.

### BRIEF SUMMARY OF THE DISCLOSURE

Briefly stated, one aspect of the present disclosure is directed to a portable mixed drink dispensing unit. The unit comprises a portable enclosure defining an interior space and a door attached thereto. The door is movable between an open position for providing access to the interior space, and a closed position, for closing off at least a portion of the interior space. A first reservoir within the interior space is secured to the enclosure and is fluidly connectable to at least one liquid container containing a first liquid. A removable second reservoir within the interior space contains a second liquid. A mixing unit located within the interior space has an inlet and an outlet. The mixing unit is in individual fluid communication at the inlet with the first and second reservoirs for separately receiving the first and second liquids. The mixing unit is configured to prepare a mixed drink by mixing the first and second liquids at a predetermined ratio, and to output the mixed drink via the outlet. A tap lever is in fluid communication with the outlet of the mixing unit, for dispensing the mixed drink.

### BRIEF DESCRIPTION OF THE DRAWINGS

The foregoing summary, as well as the following detailed description of the disclosure, will be better understood when read in conjunction with the appended drawings. For the purpose of illustrating the disclosure, there is shown in the drawings an embodiment which is presently preferred. It should be understood, however, that the disclosure is not limited to the precise arrangements and instrumentalities shown. In the drawings:

FIG. 1 is a perspective front and side view of a portable mixed drink dispensing unit according to a preferred embodiment of the present disclosure, with the door thereof in a closed position;

FIG. 2 is a perspective front and side view of the portable mixed drink dispensing unit of FIG. 1, with the door in an open position and a first reservoir in a first position;

FIG. 3 is a perspective front and side view of the portable mixed drink dispensing unit of FIG. 1, with the door in the open position and the first reservoir in a second position; and

FIG. 4 is a schematic block diagram of the portable mixed drink dispensing unit of FIG. 1, showing the operational components of the dispensing unit, and the operative connection therebetween.

### DESCRIPTION OF THE DISCLOSURE

Certain terminology is used in the following description for convenience only and is not limiting. The words “lower,” “bottom,” “upper” and “top” designate directions in the drawings to which reference is made. The words “inwardly,” “outwardly,” “upwardly” and “downwardly” refer to directions toward and away from, respectively, the geometric center of the dispensing unit, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import. It should also be understood that the terms “about,” “approximately,” “generally,” “substantially” and like terms, used herein when referring to a dimension or characteristic of a component of the disclosure, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

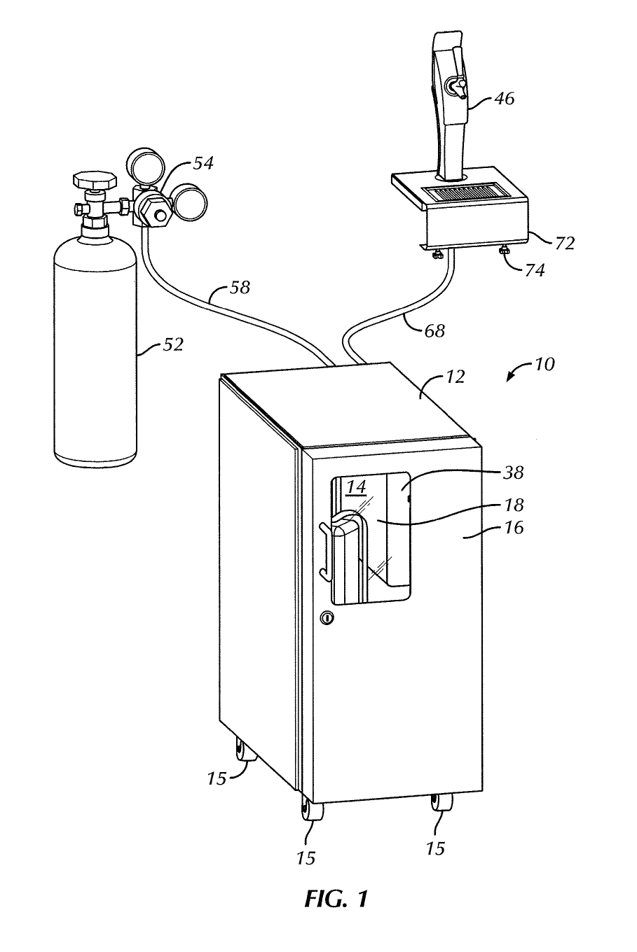

Referring to the drawings in detail, wherein like numerals indicate like elements throughout, there is shown in FIGS. 1-4 a portable mixed drink dispensing unit, generally designated 10, according to a preferred embodiment of the present disclosure. As should be understood by those of ordinary skill in the art, the term “portable” means that the dispensing unit 10 is configured to be movable, transportable or conveyable, such as, for example, without limitation, via wheels or casters as shown.

As shown in FIG. 1, the dispensing unit 10 comprises a portable enclosure 12. In the illustrated embodiment, the enclosure 12 is a substantially rectangular enclosure having opposing, and parallel, top and bottom panels, left and right panels, and front and rear panels. The panels define an interior space 14 therebetween. In the illustrated embodiment, the front panel is a front door 16 pivotably attached to the enclosure 12, for example by a pair of hinges. The enclosure 12 also includes a plurality of wheels or casters 15 attached to an underside of the enclosure 12 for transporting the drink dispensing unit 10. However, as should be understood by those of ordinary skill in the art, the enclosure 12 may take any of numerous different shapes and geometries capable of performing the function of the enclosure 12 as described herein, the door 16 may be located in numerous different positions on the enclosure 12, and some other structure, such as rollers, may be utilized to facilitate movement of the enclosure 12.

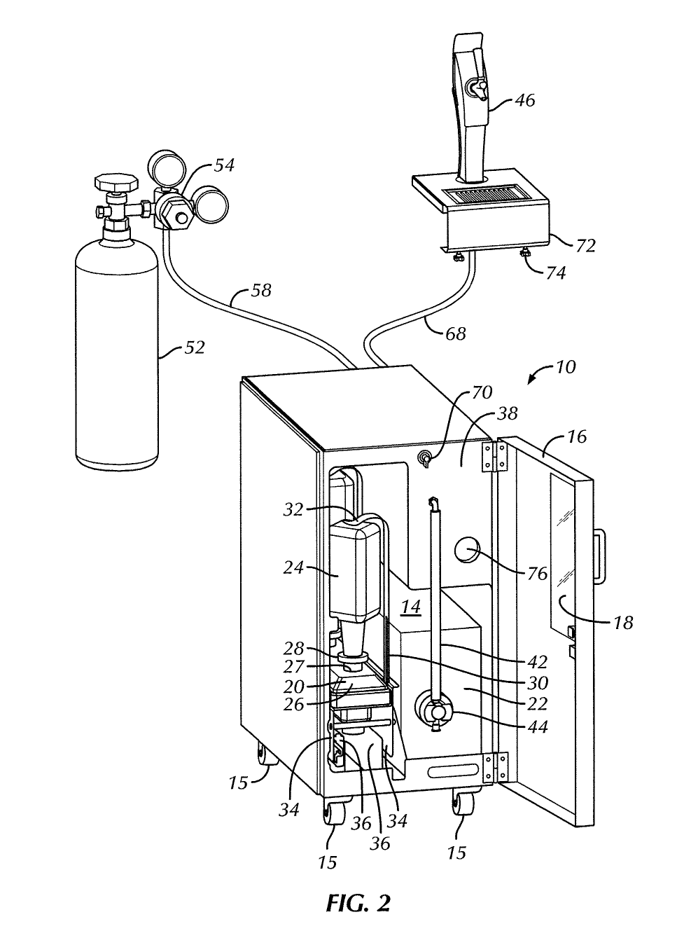

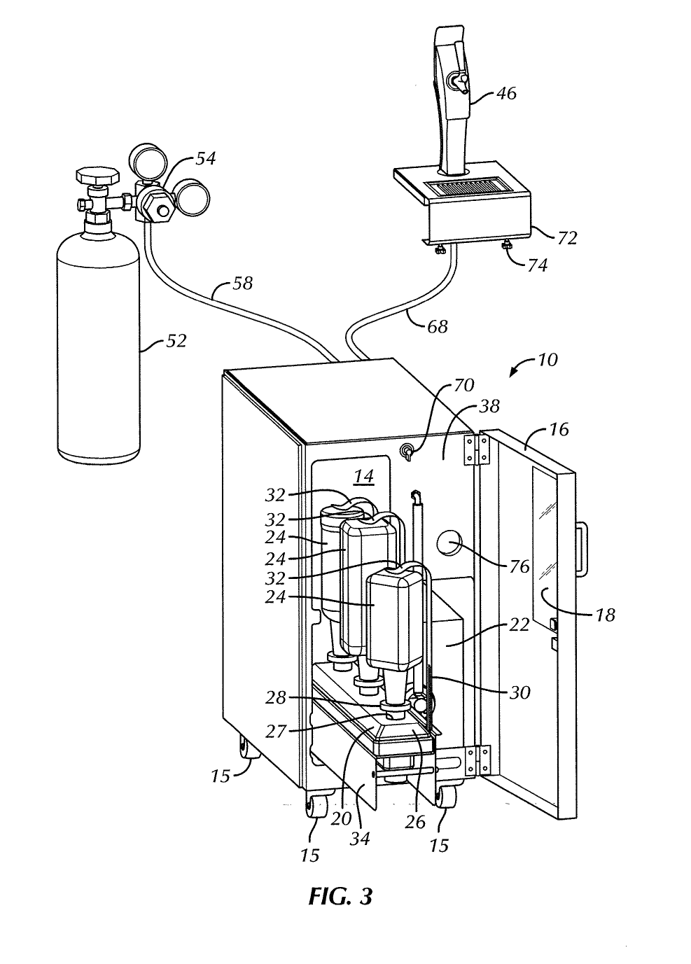

The door 16 is movable between an open position (FIGS. 2, 3), for providing access to the interior space 14, and a closed position (FIG. 1), for closing off at least a portion of the interior spaced 14. As should be understood by those of ordinary skill in the art, the door 16 may be maintained in the closed position via any of numerous different conventional means, such as, for example, via a magnetic coupling between the door 16 and the enclosure 12 or via a latch or lock.

As shown, the door 16 preferably includes a window 18 exposing at least a portion of the interior space 14 when the door 16 is in the closed position, as will be described further below.

As shown in FIGS. 2 and 3, the interior space 14 of the enclosure 12 includes a first reservoir 20 and a second reservoir 22. The first reservoir 20 is secured to the enclosure 12, as will be described further below. As shown, the first reservoir 20 is also fluidly connected to at least one liquid container 24, which fills the reservoir 20 with a first liquid for the mixed drink. In the illustrated embodiment, the first reservoir 20 is fluidly connected to three liquid containers 24, each containing a first liquid. The liquid containers 24 may be of the same or different size and each container 24 may contain the same or different first liquid. The second reservoir 22 contains a second liquid for the mixed drink, and is removably mounted in the enclosure 12. In a preferred embodiment, the first reservoir 20 is an alcohol spirit reservoir, the liquid containers 24 each contain an alcohol spirit, e.g., vodka, rum, whiskey, or other types of liquor, and the second reservoir 24 is a non-alcoholic liquid reservoir. For example, the second reservoir 24 may be an interchangeable bag-in-box, e.g., a three gallon juice bag-in-box. The mixed drink that is prepared by the dispensing unit 10 is preferably a cocktail. As should be understood by those of ordinary skill in the art, however, the portable dispensing unit 10 may be utilized to prepare a variety of different alcoholic or non-alcoholic mixed drinks, and the first and second reservoirs 20, 22 may contain a variety of different alcoholic or non-alcoholic liquids.

As shown best in FIG. 3, the first reservoir 20 includes an inlet manifold 26. The inlet manifold has a plurality of inlets 27, for fluid connection with the liquid containers 24, thereby increasing the amount of the first liquid, i.e., alcohol spirit, prior to requiring replacement of the liquid containers 24. The inlet manifold 26 includes an inlet 27 for each liquid container 24 in communication therewith, each inlet 27 having a coupler 28 for substantially secure, leak-free, and simple coupling and decoupling with a dispensing opening of a container 24. As shown, the liquid containers 24 are oriented upside down, such that the liquid therein flows into the first reservoir 20 under the force of gravity.

To stabilize the liquid containers 24 in their upside down orientation, the first reservoir 20 includes a support member 30 for each container 24, as shown in FIGS. 2 and 3. The support member 30 extends upwardly from, and substantially perpendicular to, the reservoir 20 and includes a cantilever spring 32 at a distal end thereof. When a liquid container 24 is coupled with the first reservoir 20, the rear or bottom end of the container 24 engages and flexes the cantilever spring 32 slightly away from an original position thereof, and, in turn, the spring 32 applies a downward force on the container 24, thereby stabilizing the container 24 in the upside down orientation. The container 24 is manually removable from engagement with the reservoir 20 and the support member 30. As should be understood by those of ordinary skill in the art, however, the liquid container(s) 24 may be supported in the upside down position via any of numerous different means currently known, or that later become know, such as, for example, without limitation, via a container support component of the coupler 28 or a container support assembly projecting upwardly from the inlet 27.

For easy access to the first reservoir 20, such that, for example, the liquid containers 24 can be easily replaced when emptied, the reservoir 20 is slidable between a first position (FIG. 2), wherein the reservoir 20 is located entirely within the interior space 14 of the enclosure 12, and a second position (FIG. 3), wherein when the door 16 is in the open position, the reservoir 20 is located at least partially outside of the interior space 14. In the illustrated embodiment of FIG. 3, the reservoir 20 is slidable until it is located substantially entirely outside of the interior space 14 of the enclosure 12. In order to slide, the reservoir 20 is supported by a rail member 34 that is slidably engaged with an underlying track 36 in a manner well understood by those of ordinary skill in the art. The track 36 is secured to the enclosure 12. The rail member 34 is slidable along the track 36 between the first and second positions of the reservoir 20. As should be understood by those of ordinary skill in the art, however, the reservoir 20 may be movable between the first and second positions in any of numerous different manners currently know or that later become known.

Alternatively, and similarly to the second reservoir 22, the first reservoir 20 may be removable from the enclosure 12, rather than secured thereto, in order to replace the liquid containers 24.

As shown in FIG. 2, the mixed drink dispensing unit 10 further includes a mixing unit 38 in the interior space 14 of the enclosure 12. In the illustrated embodiment, the mixing unit 38 comprises an enclosed compartment integrally formed with the portable enclosure 12. However, as should be understood, the mixing unit 38 may alternatively comprise a separate compartment secured within the enclosure 12. The mixing unit 38 is configured to prepare a mixed drink by mixing the first and second liquids at a predetermined ratio, and to output the mixed drink via an outlet thereof, as described below. A tap lever 46 is connected in fluid communication with the outlet of the mixing unit 38, for dispensing the mixed drink.

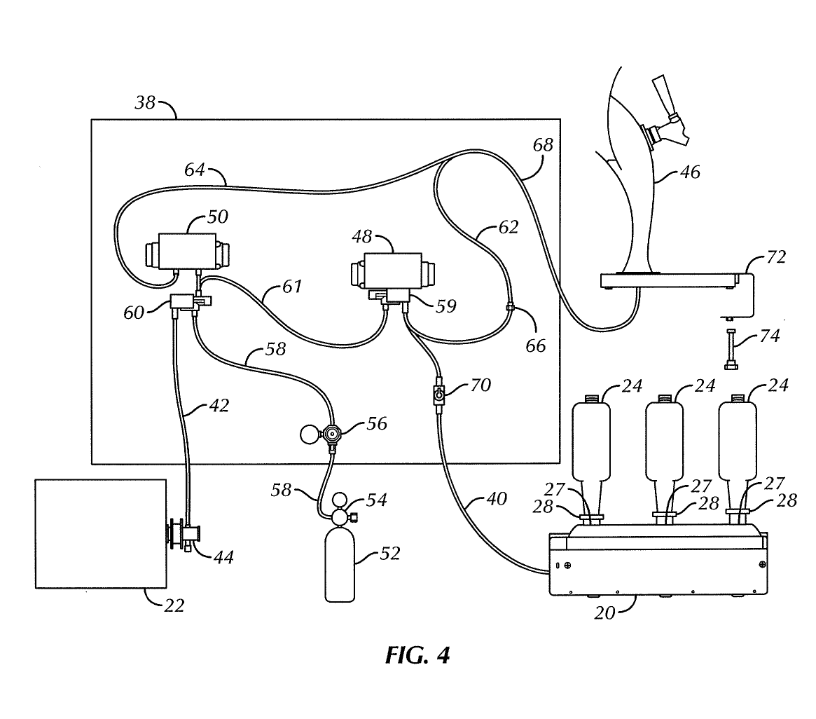

For ease of description, the internal components of the mixing unit 38 and the fluid communication between the different components of the dispensing unit 10 are shown schematically in FIG. 4. As shown in FIG. 4, the mixing unit 38 is in individual fluid communication at an inlet thereof with the first and second reservoirs 20, 22 for separately receiving the first and second liquids. That is, as should be understood by those of ordinary skill in the art, the first reservoir 20 is connected to the mixing unit 38 via a fluid line 40 for the flow of a first liquid therethrough, and the second reservoir 22 is connected to the mixing unit 38 via a separate fluid line 42 for the flow of the second liquid therethrough. As the entire second reservoir 22, e.g., the bag-in-box, is removable and interchangeable, it is connected to the fluid line 42 via a standard easy connect and disconnect connector 44 known in the art. For example, without limitation, the second reservoir 22 may be connected to the fluid line 42 via a QCD II connector, manufactured by Liqui-box.

The mixing unit 38 includes a first pump 48 in fluid communication, via the fluid line 40, with the first reservoir 20, and a second pump 50 in fluid communication with the second reservoir 22, via the fluid line 42, for pumping the first and second liquids from the reservoirs and through the mixing unit 38. As should be understood by those of ordinary skill in the art, the pumps 48 and 50 are positive displacement pumps, such as, for example, without limitation, diaphragm pumps. For example, the pumps 48 and 50 may be model N5000 diaphragm pumps, manufactured by Flojet.

The pumps 48 and 50 are operated by a compressed gas canister 52, such as, for example, a CO₂ tank. In the illustrated embodiment the canister 52 is located externally to the enclosure 12. However, as should be understood by those of ordinary skill in the art, the compressed gas canister 52 may alternatively be located within the enclosure 12. The CO₂ tank 52 is operatively connected to the first and second pumps 48 and 50 in a manner well understood by those of ordinary skill in the art, such as, for example, via gas line 58. In the illustrated embodiment, the CO₂ tank 52 includes a pressure regulator 54 attached thereto. The mixing unit 38 includes an additional conventional pressure regulator 56 therein, along gas line 58, such as, for example, without limitation, an R07 pressure regulator manufactured by Norgren. In a preferred embodiment, the CO2 tank 52 has an internal pressured of approximately 1,000 psi. The regular 54 modulates the pressure down to approximately 100 psi. The regulator 56 subsequently modulates the pressure down to approximately within the range of about 30 psi to 40 psi. As shown best in FIG. 2, the mixing unit 38 compartment includes an aperture 76, through which a gauge of the pressure regulator 56 displays the pressure.

In the illustrated embodiment, the mixing unit 38 further includes first and second conventional auto shutoff valves 59, 60, for each of the first and second pumps 48, 50, respectively. The shutoff valves 59, 60 stop the respective pumps 48 and 50 by shutting off the gas supply thereto when the first and/or second reservoirs 20, 22 are empty or low on liquid. Gas line 58 is connected from the CO₂ tank to the second shutoff valve 60. Gas line 61 connects the second shutoff valve 60 with the first shutoff valve 59. Thus, once the second reservoir 22 is empty, or low on liquid, the second shutoff valve 60 will turn off air to both pumps 48 and 50. This is important where the first reservoir 20 contains alcohol spirit and the second reservoir 22 contains a non-alcoholic liquid, to ensure that the dispensing unit 10 does not dispense pure alcohol spirit, or a relatively high content of alcohol spirit, when the non-alcoholic liquid is low or has been entirely consumed. However, as should be understood by those of ordinary skill in the art, the CO₂ tank may alternatively be directly and separately connected to each of the first and second auto shutoff valves 59, 60.

The first and second pumps 48, 50 pump the first and second liquids, respectively, into respective downstream fluid lines 62, 64. In the illustrated embodiment, the fluid line 62, containing the first liquid, e.g., the alcohol spirit, includes a flow control orifice 66. The flow control orifice 66 regulates the volumetric flow of first liquid flowing therethrough in a manner well known by those of ordinary skill in the art. For example, in a preferred embodiment, the flow control orifice 66 regulates the volumetric flow of the first liquid to be one-third of the volumetric flow of the second liquid, e.g., non-alcoholic liquid, flowing through the fluid line 64. However, as should be understood by those of ordinary skill in the art, the flow control orifice 66 may be changed or modified to regulate the volumetric flow of the first liquid flowing therethrough by any factor relative to the volumetric flow of the second liquid flowing through fluid line 64. Alternatively, both of the fluid lines 62 and 64 may include respective flow control orifices, wherein one of the flow control orifices restricts the flow of liquid at a predetermined factor relative to the other flow control orifice.

The fluid lines 62 and 64 join into a single fluid line 68 downstream of the fluid control orifice 66, thereby creating the mixed drink. The first liquid and the second liquid are mixed together at a substantially fixed ratio of the volumetric flow of the first liquid downstream of the flow control orifice 66, and the unrestricted volumetric flow of the second liquid through the fluid line 64. Thus, for example, if the flow control orifice 66 regulates the downstream volumetric flow through the fluid line 62 by one-third of the unrestricted volumetric flow through the line 64, then the mixed drink flowing through fluid line 68 will contain approximately three parts of the second liquid to one part of the first liquid, i.e., 3 parts non-alcohol to 1 part alcohol. Fluid flow line 68 flows out of the outlet of the mixing unit 38 and into the tap lever 46, for dispensing the mixed drink.

As shown, the tap lever 46 is a mobile tap lever having a clamp member 72 at a base end thereof for clamping onto an end of a structure, such as a table or bar. The clamp member 72 includes tightening means 74, e.g., a screw, for tightening the clamp member 72 onto the end of a structure, thereby securing the tap lever 46.

In use, the portable mixed drink dispensing unit 10 can be transported to any location where dispensing of mixed drinks is required. At the site, the tap lever 46, fluidly connected with the mixing unit 38 of the enclosure 12 can be clamped onto an appropriate structure via the clamp member 72. An operator may open the door 16 and place a full second reservoir 22, e.g., bag-in-box within the interior space 14 of the enclosure 12 and connect the reservoir with the fluid line 42, via the connector 44. The operator may also slide the first reservoir 20 into the second position, place the upside down liquid containers 24 atop the first reservoir 20 into the couplers 28, and then slide the first reservoir 20 back into the first position. The compressed gas tank 52, connected to the pumps 48, 50, may then be turned on, thereby allowing the pumps 48 to 50 to pump the first and second liquids from the first and second reservoirs, 20, 22, respectively, and into the mixing unit 38. The first liquid is pumped through the pump 48 and the flow control orifice 66, to substantially fix the ratio of the volumetric flow of the first liquid relative to the second liquid flowing through the line 64, such that the first and second liquids are mixed at the predetermined ratio. Accordingly, when an operator opens the tap lever 46, the mixed drink pours out having a fixed amount of first liquid in relation to the second liquid.

Once the removable second reservoir 22 is emptied, the operator may replace it. Once the liquid containers 24 are emptied, a user may pull the first reservoir 20 into the second position, replace the liquid container(s) 24, and push the reservoir 20 back into the first position. A user can monitor the level of the first liquid in the liquid containers 24 through the window 18 in the door 16, while the door 16 is in the closed position.

For cleaning purposes, the first reservoir 20 may be connected with liquid containers 24 containing sanitizing solution and the second reservoir 22 may be replaced with a reservoir also containing sanitizing solution. Then the entire dispensing unit 10 is run and the tap 46 is opened, such that the sanitizing solution flows through and cleans the entire system. For cocktail dispensing units, where the first reservoir 20 contains alcohol spirit, harmful products, e.g., bacteria, are unlikely to grow in the fluid lines 40 and 62 through which the unmixed alcohol spirit flows, or in the first pump 48. However, as a non-alcoholic liquid is contained in the second reservoir 22, e.g., juice, sanitizing of the lines 42, 64, 68 and the second pump 50 remains necessary. Thus, the mixing unit 38 further includes a shutoff valve 70 in the fluid line 40 for the first reservoir 20, as shown schematically in FIG. 6. As shown in FIGS. 2 and 3, the shutoff valve 70 lever is located at the front face of the mixing unit 38, allowing a user to toggle between the on and off positions of the valve 70. Therefore, for sanitizing the system, the second reservoir 22 may replaced with a reservoir containing a sanitizing solution and the shutoff valve 70 may be turned into the off position, thereby preventing flow from the first reservoir 20 through the system. The system may then be run, and the sanitizing solution will flow through the line 42, second pump 50, lines 64 and 68, and out the tap 46, to clean the components of the dispensing unit 10 through which the non-alcoholic drink flows.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

We claim:

1. A portable mixed drink dispensing unit comprising:
a portable enclosure defining an interior space and having a door attached thereto, the door being movable between an open position for providing access to the interior space and a closed position, for closing off at least a portion of the interior space;
a first reservoir within the interior space, secured to the enclosure and fluidly connectable to at least one liquid container containing a first liquid;
a removable second reservoir within the interior space, containing a second liquid;
a mixing unit within the interior space has an inlet and an outlet, said mixing unit being in individual fluid communication at the inlet with the first and second reservoirs for separately receiving the first and second liquids, said mixing unit being configured to prepare a mixed drink by mixing the first and second liquids at a predetermined ratio, and to output the mixed drink via the outlet; and
a tap lever in fluid communication with the outlet of the mixing unit, for dispensing the mixed drink.

2. The portable mixed drink dispensing unit of claim 1, wherein the first reservoir includes an inlet manifold having at least one inlet for fluid communication with the at least one liquid container.

3. The portable mixed drink dispensing unit of claim 2, wherein the at least one inlet of the inlet manifold comprises a coupler for coupling with a dispensing opening of the at least one liquid container.

4. The portable mixed drink dispensing unit of claim 1, wherein the first reservoir includes at least one support member extending upwardly from the reservoir, having a cantilever spring at a distal end thereof for removably engaging and stabilizing the at least one liquid container.

5. The portable mixed drink dispensing unit of claim 1, wherein the first reservoir is slidable between a first position, wherein the reservoir is located entirely within the interior space of the enclosure, and a second position, wherein the reservoir is at least partially outside of the interior space, for replacing the at least one liquid container.

6. The portable mixed drink dispensing unit of claim 5, wherein the first reservoir is supported by a rail member slidably engaged with an underlying track member secured to the enclosure, wherein the rail member is slidable along the track member between the first and second positions.

7. The portable mixed drink dispensing unit of claim 1, wherein the mixing unit comprises a compartment integrally formed with the portable enclosure.

8. The portable mixed drink dispensing unit of claim 1, wherein the mixing unit includes a first pump in fluid communication with the first reservoir, a second pump in fluid communication with the second reservoir, and a downstream first flow control orifice in fluid communication with the first pump for regulating volumetric flow of the first liquid relative to volumetric flow of the second liquid flowing from the second pump, wherein the first liquid flowing out of the first flow control orifice is fluidly communicated with the second liquid, to, in turn create a mixed drink flow exiting the mixing unit via the outlet thereof.

9. The portable mixed drink dispensing unit of claim 8, further comprising a compressed gas canister operatively connected to at least one of the first and second pumps.

10. The portable mixed drink dispensing unit of 8, wherein the first liquid is an alcohol, the second-liquid is a non-alcoholic liquid, the mixed drink is a cocktail, and the first flow orifice reduces the volumetric flow of the first liquid by a factor of one-third, for mixing the non-alcoholic liquid and the alcohol at the predetermined fixed ratio of approximately 3 parts non-alcohol to 1 part alcohol.

11. The portable mixed drink dispensing unit of claim 1, wherein the door includes a window exposing at least a portion of the at least one liquid container when the door is in the closed position.

12. The portable mixed drink dispensing unit of claim 1, wherein the removable second reservoir is an interchangeable bag-in-box.

13. The portable mixed drink dispensing unit of claim 12, wherein the bag-in-a-box is a 3 gallon juice bag-in-box.

14. The portable mixed drink dispensing unit of claim 1, wherein the portable enclosure further comprises a plurality of casters attached to an underside of the enclosure for rolling the drink dispensing unit.

The portable mixed drink dispensing unit of claim 1, wherein the tap lever includes a clamp member at a base end thereof for clamping onto a structure.

16. The portable mixed drink dispensing unit of claim 1, wherein the first reservoir is an alcohol spirit reservoir, the liquid container contains an alcohol spirit, the second reservoir is a non-alcoholic liquid reservoir, and the mixed drink is a cocktail.

17. The portable mixed drink dispensing unit of claim 1, wherein the portable enclosure includes top, bottom, left, right, front and rear panels defining the interior space therebetween; at least a portion of said front panel being the front door, and wherein the front door is pivotably attached to the enclosure.
